(19) United States
(12) Patent Application Publication
(10) Pub. No.: US 2008/0229523 A1
(43) Pub. Date: Sep. 25, 2008

(54) Apparatus for Reactivating Adhesive Substances for Shoes Parts

(75) Inventors: Juan Alberto Lopez Carbonell, Petrer Alicante (ES); Jose Luis Beaus Navarro, Alicante (ES); Jose Miguel Martin Martinez, Campello Alicante (ES)

Correspondence Address: LUCAS & MERCANTI, LLP, 475 PARK AVENUE SOUTH, 15TH FLOOR, NEW YORK, NY, 10016, US

(73) Assignees: Francesso Cottino, Vigevano (PV) (IT); CELTECNIA S.L., Monovar (ES)

(21) Appl. No.: 11/997,687

(22) PCT Filed: Jul. 27, 2006
(86) PCT No.: PCT/IB2006/002044

§ 371 Date: Feb. 28, 2008

(30) Foreign Application Priority Data
Aug. 5, 2005 (IT) MI2005A001554

(51) Int. Cl. A43D 117/00; A43D 89/00; A43D 11/14; A43D 11/00; H05B 1/00; A43D 25/20

(52) U.S. Cl. 12/1 A; 12/33.2; 12/41.5; 12/142 R; 219/215

(57) ABSTRACT

Apparatus for reactivating adhesive substances previously deposited on one or more parts of shoes (8), of the type comprising at least one heating device (4,5) of said one or more parts of shoes (8) and at least one controlling unit regulating the operating conditions of said at least one heating device (4,5). The apparatus includes, furthermore, one or more sensors (11) for the detection of the conditions of temperature and/or humidity of the aforesaid one or more parts of shoes (8), said one or more sensors (11) being located either upstream and/or downstream of the aforesaid at least one heating device (4,5) of the parts of shoes (8).

### FIELD OF THE INVENTION

The present invention relates to a method and a related apparatus for reactivating adhesive substances spread on parts of shoes (or footwear), which, after the deposition of such adhesive substances and the drying, natural or forced, of the latter, must be joined for the completion of the same footwear.

### BACKGROUND ART

It is known in the art to produce the mutual attachment of parts of shoes, such as for instance the sole to the upper, or the insole to the sole of a shoe, by gluing, achieved by adhesive substances of the neoprene, polyurethane, water-based type or of another type again, such as for instance, thermoplastic-resin based type.

In more detail, the attachment of parts of shoes by adhesive, also defined “cementation”, provides for a first step of spreading of the adhesive on the parts of shoe to be glued, and, thereafter, a subsequent step of drying of the adhesive for the purpose of getting perfect adherence of the adhesive to the part of shoe on which it has been spread and at the same time to prevent the adhesive in the liquid state to cause the unwanted gluing of parts of shoe not perfectly lined up, or not complementary one to the other, during the transport of the same glued parts.

At the end of such step of drying, for instance produced in electric-resistance ovens, or by forced-flow warm-air heating devices, or under vacuum in suitably heated chambers, the glue spread on the parts of shoes is not active and therefore requires to be reactivated thermally before the following step of mutually joining the complementary parts of the shoes.

By way of example, the American patent U.S. Pat. No. 4,910,822 in the name of Paolucci, describes a device for drying water-based adhesives for parts of shoes, of the type comprising a vacuum chamber heated by halogen lamps.

As to the thermal reactivation step of the dried adhesives, apparatuses are known in the art which, by supplying heat for a brief time and at a temperature depending on the type of adhesive used (for instance around 120° C. for neoprene adhesive and around 200° C. for thermoplastic resin adhesive), have the purpose of reactivating, or making adhesive again, the dried adhesives present on the parts of shoes that it is intended to join definitively by mutual gluing. Such apparatuses, for instance comprising quartz lamps or simpler electric resistances, are for instance described in the patents GB-A-823.959, which suggests regulating the heat of reactivation as a function of the adhesive used and of the type of shoe being in process in, U.S. Pat. No. 2,549,981 which suggests simultaneously reactivating the adhesive present on the sole and on the complementary upper of a shoe, or GB-A-1.119.871, in which a flow of cold air is directed onto parts of the shoes without adhesive to allow their transport by hand after the reactivation.

In particular, U.S. Pat. No. 4,267,429 in the name of FLEER, in an apparatus for reactivating the adhesives spread on parts of shoes, suggests using a control unit to regulate the timing and heating conditions of one or more consecutive steps of reactivation of the said adhesives spread on the parts of shoes. The control unit is also programmable and acts on the basis of a set of instructions previously defined by the operator, as a function of the type of shoe and of the adhesive used.

The European patent application EP-A-0.512.526 in the name of IRON FOX describes an integrated production line for the assembly of glued parts of shoes, comprising, in succession, means for drying the glue and an apparatus for the later reactivation of such adhesive present on parts of shoes being in process.

The apparatuses for reactivating the adhesives known to the art, and briefly introduced above, usually provide that the thermodynamic conditions to which the parts of shoes having dried adhesive are subject to, i.e. the temperature, the quantity of heat supplied and the dwell time of the shoe parts inside the heat generator, are previously determined by the operator, as a function, as already stated, of the type of adhesive used and, where necessary, of the type of shoe being in process.

Such manual regulation of the operation of the reactivation apparatuses known to the art, although it is simple and, in many cases, sufficiently effective, often leads to the production of parts of shoes in which the adhesive is not reactivated so that it is suited to the succeeding operation of mechanically joining (i.e. mechanically coupling) the same parts of shoes.

In fact, even though the regulation of the heat to be transferred to the dried adhesive substances (glues) on the parts of shoes during the reactivation is determined by empirical rules on the basis of a plurality of parameters, such parameters are of a qualitative and/or macroscopic type—i.e. type of adhesive used, material, form and color of the shoe—, while possible quantitative and/or microscopic parameters—such as, for instance, the degree of drying of the adhesive substances, the distribution and the absorption of the adhesive substances on the shoe—which theoretically are determining factors in ensuring the correct conditions of supply of the reactivation heat, are entirely neglected because of the difficulty, if not impossibility, of determining them.

It is a purpose of the present invention to provide a method for reactivating the adhesive spread on parts of shoes that also considers indirectly some quantitative conditions to which the parts of shoes to be reactivated are subject to and leads to the determination of the optimal condition of supply of the heat in such reactivation, and by this enabling extremely effective recovery of the tackiness of the adhesives used.

Another purpose of the present invention is to provide an apparatus for reactivating the dried adhesives present on parts of shoes that enables reactivation of such adhesives to be obtained correctly and, in particular, in an entirely automatic way for the operator.

A further purpose of the present invention is to produce an integrated system for drying and reactivating the adhesives used on parts of shoes that automatically provides as outcome, parts of shoes with perfectly adhesive glues.

### SUMMARY OF THE INVENTION

These and other purposes are achieved by the apparatus for reactivating adhesive substances previously deposited on one or more parts of shoes according to the first independent Claim and the following dependent Claims, by the system for the thermal treatment of parts of shoes which undergo gluing according to the fourteenth independent Claim and the following dependent Claims, and by the method for reactivating adhesive substances for the gluing of parts of shoes according to the twenty-first and the twenty-fourth independent Claims and the following dependent Claims.

According to the present invention, the method for reactivating adhesive substances provided for gluing parts of shoes, following a step of deposition of the adhesive substances on one or more parts of shoes, comprises the succeeding steps of:
a) detecting, directly or indirectly, the temperature and/or the humidity of the parts of shoes;
b) reactivating, by controlled heating, the adhesive substances present on the aforesaid one or more parts of shoes.

Advantageously, according to the present invention, the operating conditions of the reactivation step by controlled heating are regulated as a function of the previously detected temperature and/or humidity of the parts of shoes.

As the Applicant has been able to surprisingly ascertain, in addition or in alternative to the color, type of adhesive, type of material and color of the glued parts of shoes used, the conditions of temperature and humidity found on the parts of shoes that undergo the step of reactivation, strongly determine the result of the following step of reactivation of the adhesive.

In particular, in the case of integrated lines or systems for the treatment of glued parts of shoes thus equipped, in succession, with means (devices) for drying and with apparatuses for reactivating the adhesives, connected by a conveyor, the Applicant has verified that the temperature and the humidity of the glued parts of shoes leaving the means of drying or a traditional reactivation apparatus, are determining for the purpose of identifying those correct thermodynamic conditions to impose in a possible later step of reactivation that leads to the optimal tackiness of the previously-dried glues.

According to another aspect of the present invention, an apparatus is provided for reactivating adhesive substances previously deposited on one or more parts of shoes, of the type comprising at least one heating device for said one or more parts of shoes and at least one control unit for regulating the operating conditions of the heating device. The apparatus includes one or more sensors for the detection of the conditions of temperature and/or humidity of the aforesaid one or more parts of shoes located upstream and/or downstream of the device for heating the parts of shoes.

It should be noted that the wording “means for the detection of the conditions of temperature and/or humidity of parts of shoes”, refers to any type of sensor able to detect the temperature and/or the humidity of the same parts of shoes or of the environment immediately surrounding such parts of shoes. Sensors of this type may comprise, for instance, sensors able to measure local humidity or infrared thermometers to measure the temperature of the parts of shoes.

Likewise, the wording “to directly or indirectly detect the temperature and/or humidity” refers to the use of any method and/or instrument that allows the conditions of temperature and/or of relative humidity of the parts of shoes being in process to be detected, even by calculation, statistics, interpolations or other.

According to a preferred aspect of the present invention, the apparatus is also provided with at least one first and one second heating device for the parts of shoes on which adhesive substances have been deposited, and at least one control unit for controlling the operating conditions of the aforesaid first and second heating devices.

In a preferred embodiment of the apparatus according to the present invention, the controlling unit regulates the operating conditions of the heating device or devices based on the signals deriving from the aforesaid sensors.

According to a further aspect of the present invention, a system or plant is provided for the thermal treatment of parts of shoes which undergo gluing, comprising at least one device for drying the adhesive gluing substances and at least one apparatus for reactivating the adhesive gluing substances on one or more parts of shoes, of the type described above. The apparatus for reactivating is located upstream of the aforesaid drying device and means are also provided for feeding the aforesaid parts of shoes to the device for drying and to the reactivation apparatus.

### BRIEF DESCRIPTION OF THE DRAWINGS

A preferred embodiment of the system for thermal treatment of glued parts of shoes and the apparatus for reactivating the adhesive substances according to the present invention and a particular form of implementation of the method according to the present invention, will now be described by way of not limiting example only, with reference to the attached figures, in which:

FIG. 1 is a schematic side view of a system for the thermal treatment of parts of shoes subjected to gluing according to a particular aspect of the present invention;

FIG. 2 is a partially exploded axonometric view of the system of FIG. 1, showing the apparatus for reactivating the adhesive substances and the outlet of the means for drying, according to another aspect of the present invention, and

FIG. 3 is a schematic side view of the apparatus for reactivating of FIG. 2, alone.

### DETAILED DESCRIPTION OF AN EMBODIMENT OF THE INVENTION

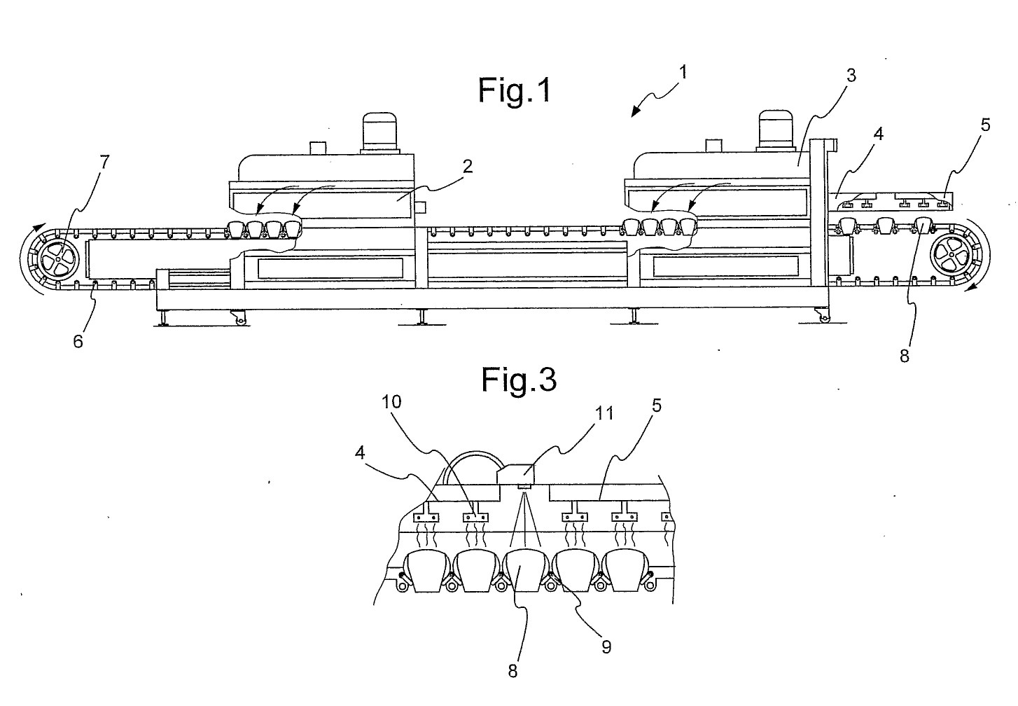

With reference first to FIG. 1, the system 1 for the thermal treatment of parts of shoes 8 to be joined by gluing, according to a particular embodiment of the present invention, comprises in succession one first and one second device 2, 3 for drying the adhesive substances placed on the parts of shoes 8 and means 6, 7, 9 for feeding such parts of shoes 8 to the devices 2 and 3.

Downstream of the drying devices 2, 3 of the adhesive, the system 1 also provides, according to an advantageous aspect of the present invention, an apparatus 4, 5 of reactivation of the adhesive substance present on the parts of shoes 8 and previously dried. The reactivation apparatus 4, 5, of the type comprising, for instance, heating elements such as electric resistances, which dissipate heat for Joule effect, or infrared or quartz lamps, is also connected to the preceding drying devices 2, 3, by the same means 6, 7, 9 for feeding the shoe parts 8. Such apparatus 4, 5 for reactivating the adhesive substances (glues) is also provided, according to the known art, with at least one control unit (not shown) regulating the operating conditions of the same apparatus 4, 5, where it has the function to regulate the conditions of supply of the heat to the parts of shoes 8 and, where necessary, to maintain constant that supply. The controlling unit could be of a manual type, and, for instance, only enable the operator to regulate by hand levers the electric power absorbed by the apparatus 4, 5, or it could be of an automatic type, and for instance allow the operator to plan and regulate the quantity of heat to supply and/or of the temperature to achieve in correspondence of the heating elements 10 (see FIG. 3), maintaining such values constant by automatic detection of the energy absorbed or of the temperature of the same heating elements 10.

The reactivation apparatus 4, 5 can include, according to a particular aspect of the present invention herein described, two heating devices 4, 5, one located in series with the other, having—where necessary—different heating elements 10 which, in this case, are advantageously regulated separately, by the aforesaid controlling unit regulating the operating conditions.

The aforesaid means for feeding 6, 7, 9, as shown in FIG. 1, can comprise a conveyor belt 6 having elastic jaws 9 to retain the parts of shoes 8 and operated by a sprocket 7, in turn connected to motor means not illustrated.

It should be observed however, that the use of a conveyor belt is here described by way of example, but other means for feeding known to the art, such as for instance, trolleys on rails or revolving carousels with mobile arms, could also be employed for transporting the parts of shoes 8 to the devices 2, 3 and to the apparatus 4, 5, with which the system 1 for thermal treatment is endowed.

According to a functional scheme already adopted by the Applicant, furthermore, the drying devices of the system 1 can include a first cold-air drying device 2 and a second warm-air drying device 3, both of the forced-air type.

It should be noted that, in the case of the drying devices, provision can be made similarly for the use of a single drying device or alternatively of a plurality of drying devices, of any type known to the art, without for this reason going beyond the scope of protection of this patent.

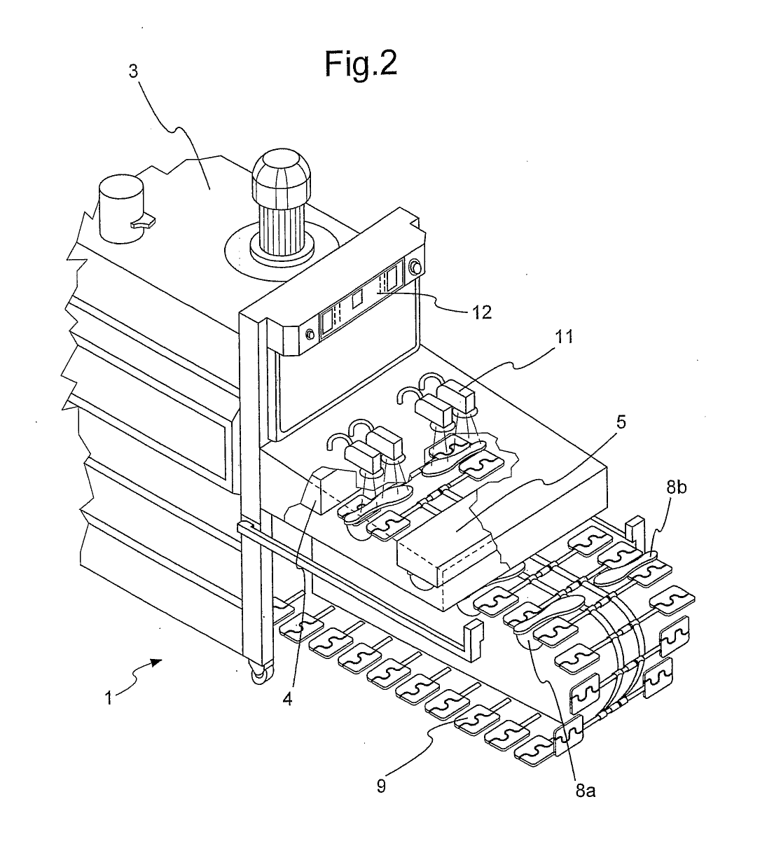

With reference to FIG. 2 also, the system 1 for thermal treatment of parts of shoes 8 can furthermore have a single automatic controlling unit, for instance, a programmable microprocessor or a PLC, having a control console 12 that allows the operator to set the thermodynamic operating conditions of the drying devices 2, 3 and of the reactivation apparatus 4, 5 (or of the heating devices 4 and 5 of such reactivation apparatus, individually).

Furthermore, the system for thermal treatment 1 can include, when dedicated to the drying and successive reactivation of adhesive substances spread on uppers 8a and soles 8b destined to be reciprocally joined, further stations (not illustrated) for gluing parts of shoes 8 located upstream of the drying devices 2, 3, and other stations for the mechanically-assisted join of the parts of shoes 8 (in this case of the uppers 8a and of the related soles 8b), located downstream of the reactivation apparatus 4, 5.

The conveyor belt 6 or other possible alternative means for feeding the parts of shoes 8 to the devices 2, 3 and to the apparatus 4, 5, can be configured in such way as to comprise two parallel lines of jaws 9, arranged to cause two complementary parts of shoes 8 destined to be glued together, e.g. an upper 8a and a sole 8b in this case, to advance simultaneously in a parallel way so that such complementary parts simultaneously undergo the same thermal treatment and therefore leave the system 1 under the same thermodynamic conditions.

According to the present invention the reactivation apparatus also includes, advantageously, one or more sensors 11 to detect, directly or indirectly, the conditions of temperature and/or humidity of the parts of shoes 8. Such sensors 11 can be located upstream or downstream of at least one of the heating devices 4 or 5, in such way to provide output signals, which can be interpreted by an operator and/or by an automatic controlling unit, that allows a precise evaluation of the conditions of reactivation of the adhesive substance on the parts of shoes 8 entering or leaving the aforesaid apparatus 4, 5 of reactivation.

The sensors 11, for instance comprising infrared thermometers and/or capacitance humidity detectors, have therefore the purpose of identifying at least one of such thermodynamic parameters (temperature and/or humidity) of the parts of shoes 8 being in process, where necessary by interpolation or by statistical processing of the detected parameters not directly relating to the parts of shoes 8, but on the contrary relating to—for instance—the environment surrounding such parts of shoes 8.

As the Applicant has been able to ascertain, in fact, the values of temperature and humidify of the parts of shoes 8 are closely related to the degree of reactivation of the adhesive, and knowing such values therefore enables the operator to identify both the correct quantity of heat of reactivation to supply, where such values of temperature and humidity are known upstream of the reactivation apparatus 4, 5, and the possible presence of parts of shoes 8 not adequately reactivated, to be discarded or to submitted for another reactivation cycle, if the values of temperature and humidity are detected downstream of the aforesaid apparatus 4, 5.

So, by way of example, the values detected or inferred, of temperature and/or humidity of the parts of shoes 8 being in process can be displayed to the operator, by for instance a suitable visual display unit, in such a way that the operator can manually set the conditions of reactivation for the parts of shoes 8 being in process, or discard the same parts 8.

Or, always by way of example, such values of temperature/humidity of the parts of shoes 8 can be sent directly to an automatic controlling unit regulating the heat supplied by the reactivation apparatus 4, 5, and the related conditions of temperature, which is able to instantly regulate such conditions of temperature and supplied heat in a closed control loop cycle, in such a way as to allow optimal reactivation of the adhesives placed on the parts of shoes 8 whose temperature and/or humidity was previously detected.

In the particular embodiment of the reactivation apparatus according to the present invention, here also illustrated with reference to FIG. 3, two separate heating devices 4 and 5 are provided, comprising respectively heating elements of the type comprising, for instance, infrared lamps and a plurality of sensors 11 for the detection of the conditions of temperature and/or humidity of the parts of shoes 8, located between the aforesaid two heating devices 4 and 5.

It should be observed that such sensors 11 could also be located upstream of the first heating device 4, or in correspondence of the outlet section of the drying device 3, or downstream of the second heating device 5.

With the particular arrangement of the sensors 11 illustrated in FIGS. 2 and 3, the detection of the conditions of temperature and/or humidity of the parts of shoes 8 leaving the first heating device 4 of the reactivation apparatus can serve to determine whether to subject the parts of shoes 8 to heating also in the second heating device 5 and what thermodynamic conditions to impose, when necessary, on such second heating device 5.

If, as is preferable, the operational parameters of temperature and supplied heat of the two heating devices 4 and 5 of the reactivation apparatus are adjustable separately by a suitable automatic controlling unit, the signals given out by the sensors 11, proportional to the conditions of temperature and/or humidity of the parts of shoes 8 leaving the first heating device 4, could be introduced into such automatic controlling unit, preferably programmable, which, using a pre-set program, and based on such signals, could decide whether to operate the following heating device 5 and, if it so decided, could also determine what operational parameters (temperature and quantity of heat supplied) to set for such following step of the reactivation in the second heating device 5.

The automatic controlling unit could calculate in this way for every part of shoes 8 (or for every pair of parts of shoes 8a, 8b) leaving the first heating device 4, whether and how to activate the second heating device 5 of the reactivation apparatus, with the purpose of obtaining optimal reactivation of the adhesive substances deposited on the same parts of shoes 8.

In the case in which there are also sensors 11 upstream of the first heating device 4 (not illustrated), a possible automatic controlling unit functionally connected to the sensors both upstream of the first heating device 4 and downstream of the latter, could regulate the operating conditions of the heating devices 4 and 5 separately, with the purpose of obtaining not only effective, but good restoration of the tackiness of the adhesive deposited on the parts of shoes 8 being in process.

If instead, as has already been mentioned, the controlling unit regulating the two heating devices 4 and 5 is of the manual type, an operator could regulate the operating conditions of the second heating device 5 based on the indications provided by such sensors 11, made available immediately in this case to the same operator by suitable means of display.

As will be clear to the person skilled in art, the system 1 for the thermal treatment of parts of shoes 8 and, particularly, the reactivation apparatus 4, 5 described above, can easily implement the method for reactivating adhesive substances placed on parts of shoes 8 according to the present invention.

Such a method, in one essential form of its implementation, provides in fact for the parts of shoes 8, on which some adhesive substances, such as neoprene-based, polyurethane-based, or water-based adhesive, etc., have been previously deposited and where such adhesive substances has dried (in a forced or natural way) to be subjected in succession to the following steps:
detecting, directly or indirectly, the temperature and/or the humidity of the parts of shoes 8 being in process;
subjecting the adhesive substances present on such parts of shoes 8 to reactivation by controlled heating;
in such a way that the operating conditions of the aforesaid step of reactivation are regulated as a function of the values of temperature and/or humidity of the parts of shoes 8, acquired as a result of the preceding detection step.

More particularly, the method of the present invention, in a form of preferred implementation with reference to the system of thermal treatment 1 described above, comprises in succession the following steps:
a. depositing on the parts of shoes 8 to be glued (for instance upper 8a and related sole 8b) a layer of adhesive substances for instance, of the neoprene, polyurethane, or water based type;
b. arranging the parts of shoes 8 on the said means for feeding and transport of the system for thermal treatment 1. If such means comprises the conveyor belt 6, arranging the parts of shoes 8 to be subjected to thermal treatment within the related jaws 9;
c. operating the conveyor belt 6 and the drying devices 2 and 3;
d. subjecting the adhesive substances present on the parts of shoes 8 to drying within the devices 2, 3, for instance, respectively of the cold and hot forced-air types;
e. operating the reactivation apparatus 4, 5, comprising a first heating device 4, a second heating device 5 and a plurality of sensors 11 to detect the temperature and/or humidity of the parts of shoes 8, located between the aforesaid first and second heating devices 4 and 5;
f. subjecting the parts of shoes 8 to a first step of reactivation of the adhesive substances within the first heating device 4, the operational parameters of such first device 4 being preferably regulated by an automatic controlling unit and being set previously, for instance, as a function of the color, type of adhesive, and type of material of the parts of shoes 8;
g. detecting the conditions of temperature and/or humidity of the parts of shoes 8 leaving the first heating device 4 of the reactivation apparatus by using the sensors 11;
h. setting the operational parameters of the second heating device 5 of the reactivation apparatus, or deactivating it when necessary, as a function of the aforesaid conditions of temperature and/or humidity of the parts of shoes 8 previously detected by the sensors 11;
i. where necessary, subjecting the parts of shoes 8 to a second reactivation step of the adhesive substances within the second heating device 5.

At the end of the possible second reactivation step of the adhesive substances of the parts of shoes 8 being in process, a step of mutual gluing by compression of the complementary parts of shoes 8a and 8b is normally provided

If some sensors 11 were provided to detect the conditions of temperature and/or humidity of the parts of shoes 8 also upstream of the first heating device 4 of the reactivation apparatus of the adhesive substance, then also the operating conditions of the aforesaid first heating device 4 could be regulated, although not exclusively, based on the detection of such sensors 11 upstream and downstream of the device 4.

1. Apparatus for reactivating adhesive substances previously placed on one or more parts of shoes, of the type comprising at least one heating device for said one or more parts of shoes and at least one controlling unit regulating the operating conditions of said at least one heating device, characterized by comprising one or more sensors for the detection of the conditions of temperature and/or humidity of said one or more parts of shoes, said one or more sensors being located upstream and/or downstream of said at least one heating device for said one or more parts of shoes.

2. Apparatus according to claim 1, characterized by said one or more sensors being functionally connected to said at least one controlling unit regulating said at least one heating device.

3. Apparatus according to claim 2 in which the output from said one or more sensors are acquired in input by said at least one controlling unit, the apparatus being characterized by said at least one controlling unit regulating the operating conditions of said at least one heating device as a function of the signals deriving from said one or more sensors.

4. Apparatus according to claim 1, characterized by said one or more sensors being associated with means for displaying the detected parameters by said one or more sensors.

5. Apparatus according to claim 1, characterized by comprising at least one first and one second heating device for said one or more parts of shoes, and at least one controlling unit regulating the operating conditions of said at least one first and one second heating device.

6. Apparatus according to claim 5, characterized by comprising one or more sensors for the detection of the conditions of temperature and/or humidity of said one or more parts of shoes, located downstream of said at least one first heating device and upstream of said at least one second heating device.

7. Apparatus according to claim 5, characterized by comprising one or more sensors for the detection of the conditions of temperature and/or humidity of said one or more parts of shoes located upstream of said at least one first heating device and by comprising one or more sensors for the detection of the conditions of temperature and/or humidity of said one or more parts of shoes located downstream of said at least one first heating device and upstream of said at least one second heating device.

8. Apparatus according to claim 1, characterized by comprising means for feeding said one or more parts of shoes to said at least one heating device.

9. Apparatus according to claim 8, characterized by said means for feeding comprising at least one conveyor belt.

10. Apparatus according to claim 9, in which said at least one conveyor belt is shaped for transporting uppers and/or soles of shoes.

11. Apparatus according to claim 1, characterized by said at least one controlling unit being of a programmable type.

12. Apparatus according to claim 1, characterized by said at least one heating device comprising quartz lamps.

13. Apparatus according to claim 1 characterized by said at least one heating device comprising lamps emitting radiation in the infrared range.

14. System for the thermal treatment of parts of shoes subject to gluing, of the type comprising at least one drying device for the adhesive gluing substances and at least one apparatus for reactivating the adhesive gluing substances on one or more parts of shoes, according to claim 1, located upstream of said at least one drying device, as well as means for feeding said parts of shoes to said at least one drying device and to said at least one reactivation apparatus.

15. System according to claim 14, in which said at least one drying device is of the type comprising a forced air-flow heating device.

16. System according to claim 14, comprising at least two drying devices, one located upstream of the other, said reactivation apparatus being arranged downstream of said at least two drying devices.

17. System according to claim 14, characterized by said reactivation apparatus comprising at least one heating device of the type provided with one or more quartz lamps and/or infrared emissions.

18. System according to claim 14, in which said means for feeding includes a conveyor belt.

19. System according to claim 14, in which said means for feeding includes supports for the parallel and simultaneous transport of two or more separate parts of a shoe.

20. System according to claim 19, in which said two or more separate parts of a shoe are parts provided for mutual gluing together on leaving said reactivation apparatus.

21. Method for reactivating adhesive substances for gluing one or more parts of shoes, following a step of deposition of said adhesive substances on said one or more parts of shoes, characterized by the succession of the following steps:
a. detecting, directly or indirectly, the temperature and/or the humidity of said one or more parts of shoes; and
b. subjecting to reactivation said adhesive substances on one or more parts of shoes by controlled heating;
the operating conditions of said step of reactivation by controlled heating being regulated as a function of the temperature and/or humidity of said one or more parts of shoes, previously detected.

22. Method according to claim 21, characterized by comprising, before said step of detecting the temperature and/or humidity of said one or more parts of shoes, a preceding step of reactivation by heating, of said adhesive substances on one or more parts of shoes.

23. Method according to claim 21, characterized by comprising, before said steps of reactivation, at least one step of drying the adhesive substances previously deposited on said one or more parts of shoes in said step of deposition of the adhesive substances.

24. Method for reactivating adhesive substances for gluing parts of shoes, following a step of deposition of said adhesive substances on one or more parts of shoes, characterized by comprising, in succession, the steps of:
a. detecting, directly or indirectly, the temperature and/or the humidity of said one or more parts of shoes;
b. subjecting to a first reactivation, by controlled heating, said one or more parts of shoes, the operating conditions of said step of first reactivation being regulated as a function of the temperature and/or humidity previously detected;
c. detecting, directly or indirectly, the temperature and/or the humidity of said one or more parts of shoes at the end of the preceding step of first reactivation; and
d. subjecting to a second reactivation, by controlled heating, said one or more parts of shoes, the operating conditions of said step of second reactivation being regulated as a function of the temperature and/or humidity previously detected.

25. Method according to claim 24, characterized by comprising, subsequently to said step of deposition of said adhesive substances, one or more steps of drying of the adhesive substances deposited on said parts of shoes.
